(19) United States
(12) Patent Application Publication
(10) Pub. No.: US 2003/0226736 A1
(43) Pub. Date: Dec. 11, 2003

(54) Dampener assembly with clamped springs

(76) Inventor: Oleg B. Krivenkoff, South El Monte, CA (US)

Correspondence Address: Boniard I. Brown, 1500 West Covina Parkway, #113, West Covina, CA, 91790-2793, US

(21) Appl. No.: 10/167,717

(22) Filed: Jun. 11, 2002

(51) Int. Cl. F16D 3/66

(52) U.S. Cl. 192/212; 464/68

(57) ABSTRACT

A damper assembly has circumferentially arranged coil springs between drive plates, and secured by retainer formations on the drive plates, and by edges of retainer plates adjacent to respective drive plates to substantially prevent relative movement between drive plates and springs to prevent springs abrasion and breakage.

### BACKGROUND AND SUMMARY OF THE INVENTION

The present invention provides improvements in vibration and shock dampening devices for use with vehicle clutches. The improvements of the invention relate to the securement in mounting of damper springs to which vibration and shock are transmitted. That is, the invention relates to improvements in the mounting of springs in vibration and shock dampening apparatus for vehicle friction clutches.

Vibration and shock dampening devices for vehicle clutches are well-known in the art, and may be typified by U.S. Pat. Nos. 1,830,746 and 2,274,174. The devices are typically embodied in assemblies interposed between a driving member and a driven member, particularly a vehicle engine and a transmission.

Damper springs are usually disposed in such assemblies between driven friction plates and a hub member or plate which are connected with a vehicle transmission, thus to provide a torsional cushion or dampener which is sufficiently yieldable to absorb torque pulsations originating from the engine.

Prior art damper assemblies have generally not provided positive assurance against at least some limited relative movement between damper springs and their mounting structures.

FIG. 1 shows a prior art assembly A with typical clutch vibration dampening assemblies which have been known for many years, and which generally include a hub member B, a drive plate C, a second drive plate (not shown), and a plurality of damper coil springs disposed in openings in the drive plates.

Abrasion and wear of spring end portions and peripheral portions, as well as spring breakage, have been caused by the features of the structures in which the springs are mounted. Some prior art devices comprise sharp edges or features where springs are retained. Any sharp edge or feature adjacent to a spring, particularly end portions of springs, causes abrasion and wear, and often breakage of a spring. As known in the art, and on occasion publicized, such spring breakage can result in destruction of a clutch assembly, etc., with parts flying about with attendant hazards of accidents and death, particularly with respect to racing cars. An example would be the breaking of a clutch damper spring while a racing car engine is operating at 10,000 rpm, thus causing various parts and assemblies to fly all about destroying the assembly and causing serious injury or death of a driver, etc., in addition to property damage.

The present invention provides substantial elimination of such hazards, and provides the advantages of improved safety, protection of drivers and vehicles.

According to the present invention, the vibration and shock dampener has a hub plate rotatably connected with an engine, first and second drive plates at opposite sides of the hub plate and rotatably mounted for a limited angular displacement of the drive plates relative to the hub plate. The drive plates are secured together and spaced apart by rivets. The first and second plates have circumferentially spaced spring retainer formations extending outwardly and oppositely from the respective plates. The drive plates preferably have window openings therein to provide cooling and for weight reduction. A plurality of circumferentially spaced coil springs, each disposed between respective retainer formations on the first and second plates and through said hub plate, and each of said retainer formations being sized and configured to firmly engage and secure a respective spring against relative movement between the spring and retainer formation.

The springs are preferably axially compressed prior to installation thereof between the drive plates, thus to provide increased clamping force between spring end portions and on edge portions of retainer plates disposed adjacent each of the first and second drive plates.

### BRIEF DESCRIPTION OF THE DRAWINGS

FIG. 1 is a perspective view of a prior art dampening apparatus;

FIG. 2 is a perspective view of a damper assembly embodying the present invention;

FIG. 3 is a perspective view of a hub plate of the damper assembly of FIG. 2;

FIG. 4 is an exploded perspective view of components of the damper assembly of FIG. 2;

FIG. 5 is a sectional view taken at line 5-5 in FIG. 2;

FIG. 6 is a sectional view taken at line 6-6 in FIG. 2;

FIG. 7 is an enlargement of the view of FIG. 5; and

FIG. 8 is an enlarged view of a portion of FIG. 6.

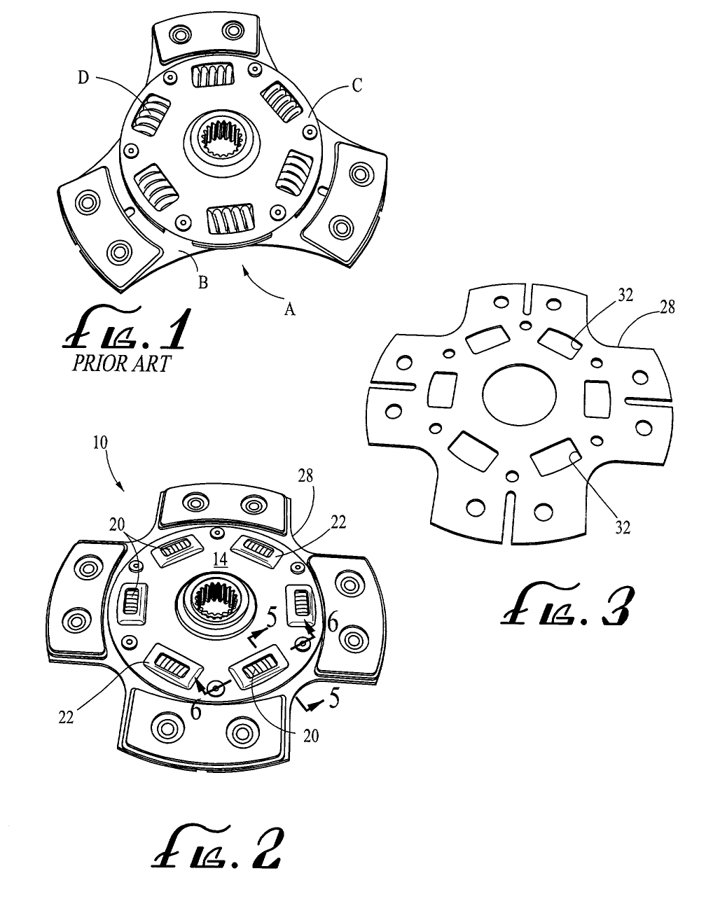

### DESCRIPTION OF THE PREFERRED EMBODIMENTS

Referring to the drawings, a damping assembly according to the present invention is illustrated in FIGS. 2 through 6. Clutch vibration dampening assembly 10 generally comprises a hub plate 12 and a pair of drive plates 14, 16 which are rotatably mounted on opposite sides of the hub plate 12 and are secured together by rivets, as shown. A plurality of damper coil springs 20 are disposed and firmly secured in respective retainer formations 22 on the drive plates, as later described.

As is well known in the art, the damper springs 20 serve to transmit torque vibration and shock from the hub plate transmitted from the road surface, and which otherwise would pass through a crankshaft and transmission with attendant engine damage in due course.

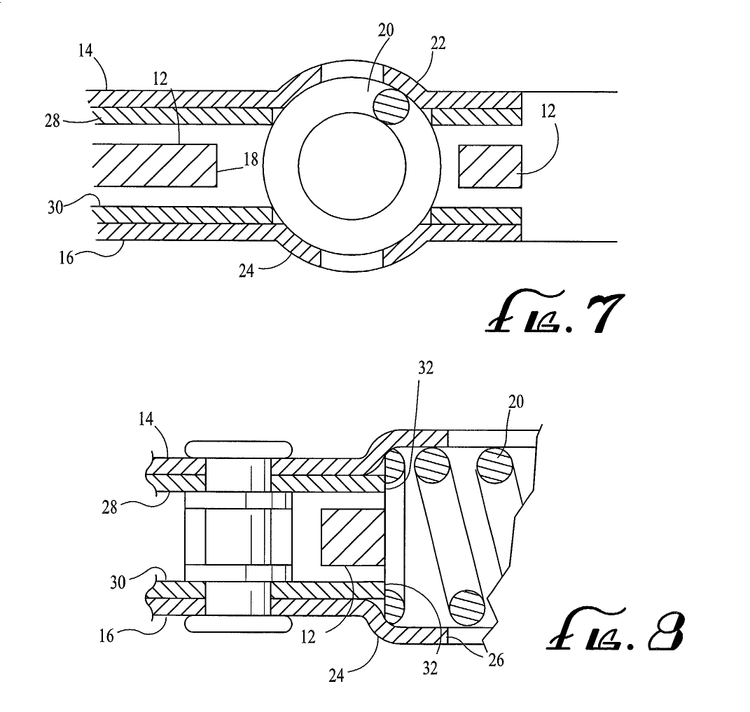

The drive plates 14, 16 undergo rotation relative to the hub plate 12, and the springs are compressed by such relative rotation between drive plates and the hub plate, thereby compressing the springs between the hub plate and the drive plates. Torque transmission occurs via the frictional surface of a clutch (FIG. 2), as is well known in the art. The relative rotation and angular displacement between the hub plate and the drive plates 14, 16 is against the action of the circumferentially spaced springs, and is limited by compression of the helical damper springs 20, the coils thereof coming into abutting relation and being compressible no further. The coaxial plates cooperate with the frictional surfaces associated therewith in transmission of motion of an input shaft of a vehicle (not shown). Drive plates are secured together and are secured apart by rivets (FIGS. 6 and 2).

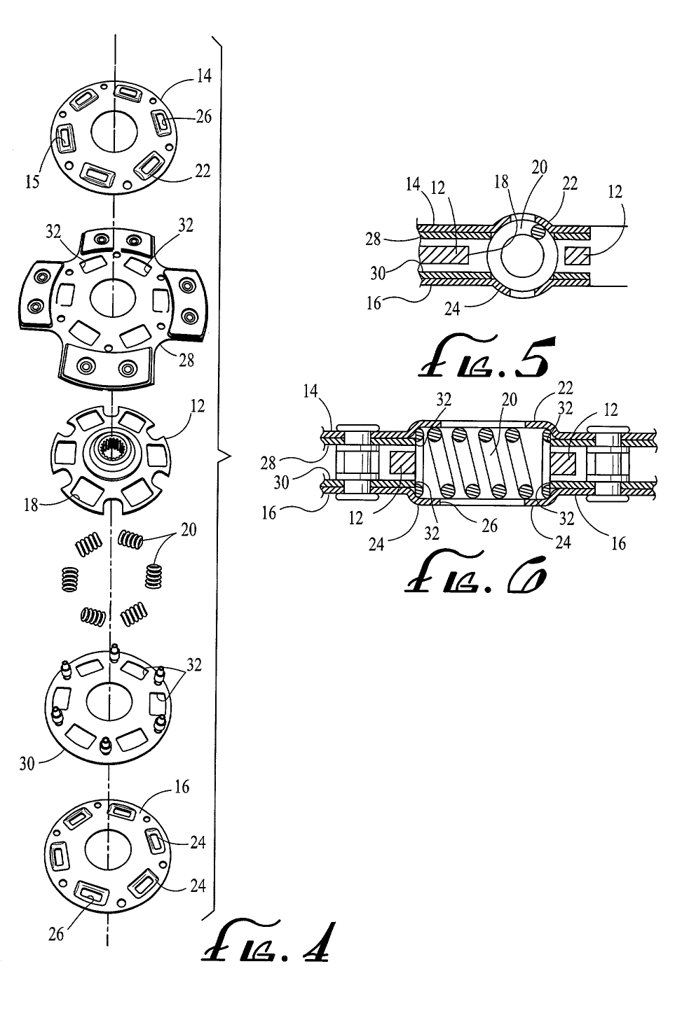

Each of springs 20 extends through one of several openings 18 defined in hub plate 12 (FIGS. 3 and 4), and is secured in a retainer formation 24, a plurality of which retainer formations are defined on each of the drive plates 14, 16, and are circumferentially disposed in spaced relation. The retainer formations extend oppositely outwardly from the drive plates on which they are defined. The retainer formations define window openings to provide cooling and weight reduction.

Each spring is firmly secured in engagement with a retainer formation 22, as indicated in FIGS. 5 and 6, which are configurated and sized to fit closely against a spring. The retainer formations secure the springs about their peripheries, and at their end portions. Each spring is preferably compressed prior to insertion in order to insure its exertion of force against its end portions to secure the spring in place.

A retainer plate 28 is disposed in underlying relation to drive plate 14, and another retainer plate 30 underlies drive plate 16 (FIG. 6). Each retainer plate extends into engagement with the ends of a spring 20 with solid, firm engagement with the spring end portions.

Each end portion of a spring is preferably ground down by machining, typically by a grinder, thus to provide substantially generally planar end surfaces of the springs to firmly engage end portions of the retainer plates, which edge portions present planar surfaces to engage the spring end portions. The retainer plates define openings with edge surfaces adjacent to the end portions of the respective springs which are adapted to firmly engage end portions of the springs.

Relative motion between each spring and its retainer formations on plates 14 and 16 is substantially prevented and eliminated. Elimination of relative movement between respective springs and their associated retainer formation structures substantially eliminates abrasion and wear, thus greatly extending the service life of the springs.

It will be understood that various changes and modifications may be made from the preferred embodiment discussed above without departing from the scope of the present invention, which is established by the following claims and equivalents thereof.

The inventor claims:

1. A vibration and shock dampener for vehicle clutches, comprising:
a hub plate rotatably connected with an engine of the vehicle, said hub plate having circumferentially spaced openings,
first and second drive plates on opposite sides of the hub plate, said plates being rotatably mounted for predetermined angular displacement relative to the hub plate,
said first and second drive plates each having circumferentially spaced spring retainer formations extending oppositely outwardly from the respective plates,
a plurality of circumferentially spaced coil springs disposed between respective retainer formations on the first and second drive plates and extending through said openings in said hub plate, said retainer formations being configurated to secure respective springs against relative movement between the springs and retainer formations, and
means defining edges adjacent to respective retainer formations and adapted to firmly engage end portions of the springs to prevent relative movement therebetween, whereby abrasion and wear of said springs are substantially prevented.

2. A dampener according to claim 1, and further comprising:
a retainer plate adjacent to at least one of said first and second drive plates and defining said edge means at openings on the at least one drive plate.

3. A dampener according to claim 1, and further comprising:
a retainer plate adjacent to each of said first and second drive plates and defining said edge means at openings in the drive plates.

4. A dampener according to claim 1, and further comprising:
first and second retainer plates respectively adjacent to and coextensive with said first and second drive plates, said plates defining openings with said edge means adjacent to end portions of respective springs and adapted to firmly engage the end portions of the springs.

5. A dampener according to claim 1, wherein at least a plurality of said coil springs are axially compressed prior to installation thereof between said first and second drive plates.

6. A dampener according to claim 1, wherein said drive plates are secured together and spaced apart by rivets.

7. A dampener according to claim 1, wherein end portions of a plurality of said springs are machined to define generally planar end surfaces to firmly engage said end portions of the retainer plates.

8. A vibration and shock dampener for vehicle clutches, comprising:
a hub plate rotatably connected with an engine of the vehicle, said hub plate having circumferentially spaced openings,
first and second drive plates on opposite sides of the hub plate, said plates being rotatably mounted for predetermined angular displacement relative to the hub plate,
said first and second drive plates each having circumferentially spaced spring retainer formations extending oppositely outwardly from the respective plates,
a plurality of circumferentially spaced coil springs disposed between respective retainer formations on the first and second drive plates and extending through said openings in said hub
plate, said retainer formations being configurated to secure respective springs against relative movement between the springs and retainer formations, and
first and second retainer plates respectively underlying said first and second drive plates and having respective openings adjacent to respective spring retainer formations on said first and second drive plates, and
said retainer plates having edge portions adjacent said respective openings and adapted to firmly engage end portions of said springs to prevent relative movement therebetween, whereby abrasion and wear of said springs are substantially prevented.

9. A dampener according to claim 8, wherein at least a plurality of said coil springs are axially compressed prior to installation thereof between said first and second drive plates.

10. A dampener according to claim 8, wherein at least some of said retainer formations on the first and second drive plates define window openings to provide cooling and weight reduction.

11. A dampener according to claim 8, wherein said drive plates are secured together and spaced apart by rivets.

12. A dampener according to claim 8, wherein end portions of a plurality of said springs are machined to define generally planar end surfaces to firmly engage said end portions of the retainer plates.

13. A vibration and shock dampener for vehicle clutches, comprising:
a hub plate rotatably connected with an engine of the vehicle, said hub plate having circumferentially spaced openings,
first and second drive plates on opposite sides of the hub plate, said plates being rotatably mounted for predetermined angular displacement relative to the hub plate,
said first and second drive plates each having circumferentially spaced spring retainer formations extending oppositely outwardly from the respective plates,
said drive plate retainer formations having window openings therein to provide cooling and weight reduction,
a plurality of circumferentially spaced coil springs disposed between respective retainer formations on the first and second drive plates and extending through said openings in said hub plate, said retainer formations being configurated to secure respective springs against relative movement between the springs and retainer formations, and
first and second retainer plates respectively underlying said first and second drive plates and having respective openings adjacent to respective spring retainer formations on said first and second drive plates, and
said retainer plates having edge portions adjacent said respective openings and adapted to firmly engage end portions of said springs to prevent relative movement therebetween, whereby abrasion and wear of said springs are substantially prevented.

14. A dampener according to claim 13, wherein at least a plurality of said coil springs are axially compressed prior to installation thereof between said first and second drive plates.

15. A dampener according to claim 13, wherein at least some of said retainer formations on the first and second drive plates define window openings to provide cooling and weight reduction.

16. A dampener according to claim 13, wherein said drive plates are secured together and spaced apart by rivets.

17. A dampener according to claim 13, wherein end portions of a plurality of said springs are machined to define generally planar end surfaces to firmly engage said end portions of the retainer plates.

18. A dampener according to claim 13, wherein each of a plurality of said springs has end portions adapted for solid engagement with end edges of said retainer plates.

19. A dampener according to claim 13, wherein:
said spring end portions are machined to define planar spring end portions, and
said retainer plates edge portions are planar to firmly engage the planar end portions of the springs to prevent relative motion therebetween.

20. A dampener according to claim 13, wherein said drive plate spring retainer formations have contoured end portions sized and configured to firmly engage and secure respective springs against relative movement between the springs and the retainer formations.
